(19) United States
(12) Patent Application Publication
(10) Pub. No.: US 2023/0371081 A1
(43) Pub. Date: Nov. 16, 2023

(54) CONFIGURING RANDOM ACCESS PROCEDURES

(71) Applicant: Lenovo (Singapore) Pte. Ltd., New Tech Park (SG)

(72) Inventors: Ali Ramadan Ali, Kraibutg am Inn (DE); Ankit Bhamri, Rödermark (DE); Karthikeyan Ganesan, Kronberg im Taunus (DE); Sher Ali Cheema, Ilmenau (DE); Vijay Nangia, Woodridge, IL (US)

(21) Appl. No.: 18/246,665

(22) PCT Filed: Sep. 27, 2021
(86) PCT No.: PCT/IB2021/058799

§ 371 Date: Mar. 24, 2023

Related U.S. Application Data
(60) Provisional application No. 63/083,486, filed on Sep. 25, 2020.

(51) Int. Cl. H04W 74/08; H04W 74/00; H04L 1/08

(52) U.S. Cl. CPC H04W 74/0833; H04W 74/006; H04L 1/08

(57) ABSTRACT

Apparatuses, methods, and systems are disclosed for configuring random access procedures. One method includes receiving, at a user equipment, a first configuration from a network. The first configuration corresponds to performing a physical random access channel transmission on multiple random access channel occasions. The method includes receiving a second configuration from the network. The second configuration corresponds to performing Msg3 repetition, MsgA repetition, or a combination thereof. The method includes performing a random access procedure based on the first configuration and the second configuration.

### CROSS-REFERENCE TO RELATED APPLICATIONS

This application claims priority to U.S. Patent Application Ser. No. 63/083,486 entitled “APPARATUSES, METHODS, AND SYSTEMS FOR COVERAGE ENHANCEMENT FOR UL DURING INITIAL ACCESS” and filed on Sep. 25, 2020 for Ali Ramadan Ali, which is incorporated herein by reference in its entirety.

### FIELD

The subject matter disclosed herein relates generally to wireless communications and more particularly relates to configuring random access procedures.

### BACKGROUND

In certain wireless communications networks, initial access channels may have poor coverage. Accordingly, transmission may be inefficient.

### BRIEF SUMMARY

Methods for configuring random access procedures are disclosed. Apparatuses and systems also perform the functions of the methods. One embodiment of a method includes receiving, at a user equipment, a first configuration from a network. The first configuration corresponds to performing a physical random access channel transmission on multiple random access channel occasions. In some embodiments, the method includes receiving a second configuration from the network. The second configuration corresponds to performing Msg3 repetition, MsgA repetition, or a combination thereof. In certain embodiments, the method includes performing a random access procedure based on the first configuration and the second configuration.

One apparatus for configuring random access procedures includes a user equipment. In some embodiments, the apparatus includes a receiver that: receives a first configuration from a network, wherein the first configuration corresponds to performing a physical random access channel transmission on multiple random access channel occasions; and receives a second configuration from the network. The second configuration corresponds to performing Msg3 repetition, MsgA repetition, or a combination thereof. In various embodiments, the apparatus includes a processor that performs a random access procedure based on the first configuration and the second configuration.

Another embodiment of a method for configuring random access procedures includes transmitting, from a network device, a first configuration. The first configuration corresponds to performing a physical random access channel transmission on multiple random access channel occasions. In some embodiments, the method includes transmitting a second configuration from the network. The second configuration corresponds to performing Msg3 repetition, MsgA repetition, or a combination thereof. A random access procedure is performed based on the first configuration and the second configuration.

Another apparatus for configuring random access procedures includes a network device. In some embodiments, the apparatus includes a transmitter that: transmits a first configuration, wherein the first configuration corresponds to performing a physical random access channel transmission on multiple random access channel occasions; and transmits a second configuration from the network. The second configuration corresponds to performing Msg3 repetition, MsgA repetition, or a combination thereof. A random access procedure is performed based on the first configuration and the second configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring random access procedures;

FIG. 2 is a schematic block diagram illustrating one embodiment of an apparatus that may be used for configuring random access procedures;

FIG. 3 is a schematic block diagram illustrating one embodiment of an apparatus that may be used for configuring random access procedures;

FIG. 4 is a schematic block diagram illustrating one embodiment of a system for multi-PRACH preamble transmission;

FIG. 5 is a schematic block diagram illustrating one embodiment of a system for multiple and/or narrow beam PRACH preamble transmission;

FIG. 6 is a schematic block diagram illustrating embodiments of PRACH preamble transmission with different SCS;

FIG. 7 is a flow chart diagram illustrating one embodiment of a 2-step RACH procedure with repetition;

FIG. 8 is a flow chart diagram illustrating another embodiment of a 2-step RACH procedure with repetition;

FIG. 9 is a flow chart diagram illustrating a further embodiment of a 2-step RACH procedure with repetition;

FIG. 10 is a flow chart diagram illustrating one embodiment of a method for configuring random access procedures; and

FIG. 11 is a flow chart diagram illustrating another embodiment of a method for configuring random access procedures.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

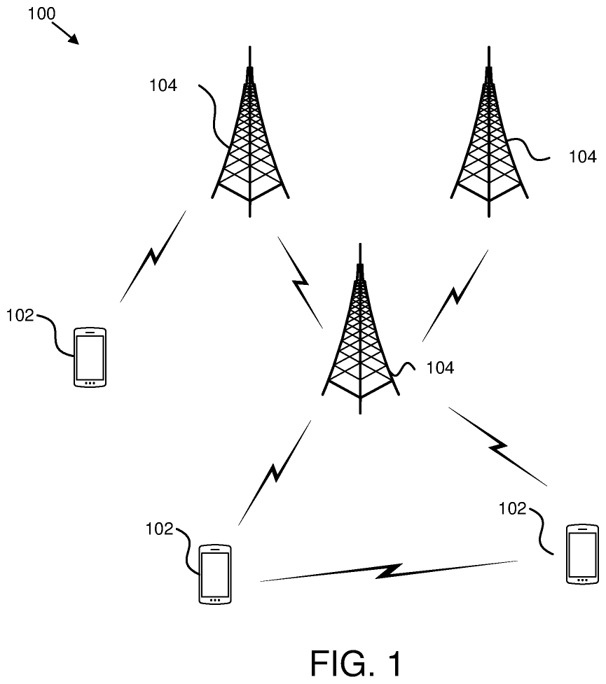

FIG. 1 depicts an embodiment of a wireless communication system 100 for configuring random access procedures. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a first configuration from a network. The first configuration corresponds to performing a physical random access channel transmission on multiple random access channel occasions. In some embodiments, the remote unit 102 may receive a second configuration from the network. The second configuration corresponds to performing Msg3 repetition, MsgA repetition, or a combination thereof. In certain embodiments, the remote unit 102 may perform a random access procedure based on the first configuration and the second configuration. Accordingly, the remote unit 102 may be used for configuring random access procedures.

In certain embodiments, a network unit 104 may transmit a first configuration. The first configuration corresponds to performing a random access procedure on multiple random access channel occasions. In some embodiments, the network unit 104 may transmit a second configuration from the network. The second configuration corresponds to performing Msg3 repetition, MsgA repetition, or a combination thereof. A random access procedure is performed based on the first configuration and the second configuration. Accordingly, the network unit 104 may be used for configuring random access procedures.

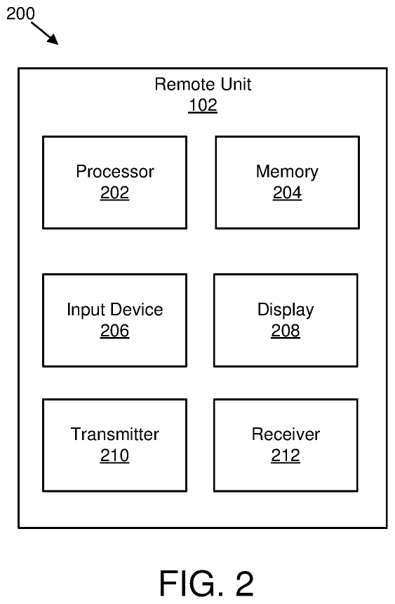

FIG. 2 depicts one embodiment of an apparatus 200 that may be used for configuring random access procedures. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives a first configuration from a network, wherein the first configuration corresponds to performing a physical random access channel transmission on multiple random access channel occasions; and receives a second configuration from the network. The second configuration corresponds to performing Msg3 repetition, MsgA repetition, or a combination thereof. In various embodiments, the processor 202 performs a random access procedure based on the first configuration and the second configuration.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

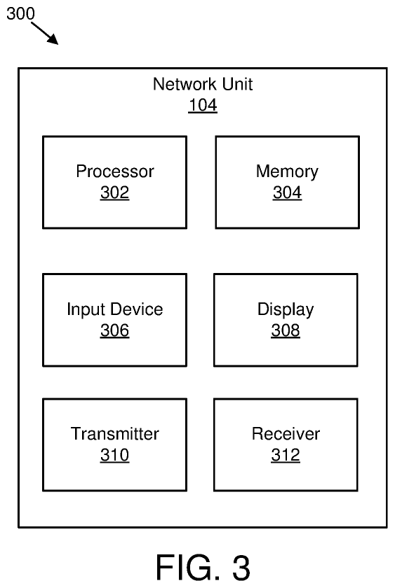

FIG. 3 depicts one embodiment of an apparatus 300 that may be used for configuring random access procedures. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310: transmits a first configuration, wherein the first configuration corresponds to performing a physical random access channel transmission on multiple random access channel occasions; and transmits a second configuration from the network. The second configuration corresponds to performing Msg3 repetition, MsgA repetition, or a combination thereof. A random access procedure is performed based on the first configuration and the second configuration.

In certain embodiments, such as in a FR2x (e.g., 52.6 GHz) band, the coverage of initial access channels and signals may be a bottleneck due to the severe attenuation loss and due to the use of low gain wide beams that depend on synchronization signal block (“SSB”) beams. Physical random access channel (“PRACH”) and Msg3 transmission may be expected to use the same transmit (“TX”) spatial filter as a receive (“RX”) spatial filter used to receive SSB beams at a user equipment (“UE”). In such embodiments, these beams may be coarser than those that are used for control and/or data transmission in connected mode, and the coverage of these messages may be limited at high frequencies. In some embodiments, hybrid automatic repeat request (“HARQ”) retransmissions for Msg3 may enhance its coverage. However, it may produce latency for an initial access procedure and may cause a selected beam in an early stage of a random access (“RA”) to be no more valid if there is no beam tracking during an applied random-access procedure.

In various embodiments, physical uplink shared channel (“PUSCH”) repetition may be used for enhancing uplink (“UL”) coverage. However, this repetition may be used in a connected mode and may not be applied for Msg3 or MsgA transmission.

In a first embodiment, there may be multiple PRACH preamble transmissions for multiple detected SSBs.

In the first embodiment, a UE may be configured with multiple random access channel occasions (“ROs”) for transmitting a PRACH preamble. Each RO is associated with at least one PRACH preamble and at least one SSB. The UE, upon detecting one or more SSB signals, lists the best SSB candidates whose reference signal received power (“RSRP”) is above a predefined threshold. The UE transmits a PRACH preamble for each (or at least two PRACH preambles e.g., corresponding to the top two SSB with highest RSRP) detected SSB without waiting for a random access response (“RAR”) message in between (e.g., before the end of the monitored Msg2 (e.g., RAR) window associated with the first PRACH preamble or in another example, without waiting for the first random-access procedure using the first preamble is declared a failure or unsuccessfully completed). In one example, a first PRACH preamble transmission associated with a first SSB, and a second PRACH preamble transmission associated with a second SSB are in time multiplexed PRACH occasions (e.g., within a PRACH slot or across PRACH slots). The multiple PRACH transmissions help to enhance both an opportunity of reception as well as coverage. In one example, the multiple PRACH transmissions use the same transmit power (e.g., without power ramping).

In certain embodiments, a UE uses the same or different preambles (e.g., a first preamble from a preamble set associated with a first SSB in a first valid PRACH occasion and a second preamble from a preamble set associated with a second SSB in a second valid PRACH occasion—the first valid PRACH occasion may be different from the second valid PRACH occasion) for each PRACH transmission corresponding to each detected SSB in associated ROs. This may increase a chance of detecting a preamble at a gNB (e.g., if during SSB detection the UE was located between the coverage (e.g., maximum power) of multiple SSB beams and during the PRACH transmission occasions the UE has moved towards the coverage of one of the beams).

In one example, more than one RSRP threshold or similar metric is pre-configured to a UE, where, if the RSRP for a given SSB beam is above a highest threshold, then the UE is expected to transmit a PRACH only on a single RO; however, if the RSRP for a given beam is below the highest configured threshold but above the second threshold, then the UE may be expected and/or configured to transmit multiple PRACH (e.g., at least two) on multiple ROs corresponding to at least the SSB beams (e.g., at least two SSB) where the RSRP is above the second threshold (but below the first threshold) and additionally may be configured corresponding to at least N neighboring SSB beams.

In another example, one or more ROs may be associated with a plurality of SSBs and a UE may repeat PRACH transmissions in one or more ROs corresponding to the detected SSBs (e.g., above certain thresholds). Each of the ROs may be associated with the same or different TX beams of a UE depending on the detection of a number of SSBs.

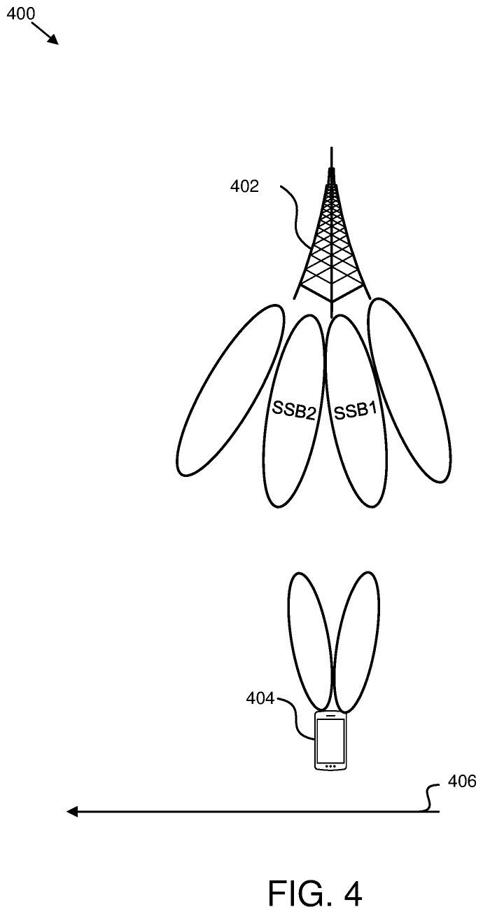

FIG. 4 is a schematic block diagram illustrating one embodiment of a system 400 for multi-PRACH preamble transmission. The system 400 includes a network device 402 (e.g., gNB) that transmits a first SSB (“SSB1”), and a second SSB (“SSB2”). The system 400 also includes a user equipment 404 moving in a direction 406.

In various embodiments, a UE repeats the same preamble for each PRACH transmission corresponding to each detected SSB in associated ROs. To enhance detection performance, a gNB may combine the multiple PRACH transmissions in the configured ROs and perform single PRACH detection.

In one example, a repetition of a PRACH preamble for each detected SSB may be transmitted multiple times (e.g., using an RO bundle that includes multiple occasions). Different SSBs may have different repeated preambles.

In a second embodiment, a PRACH repetition may be for a single detected SSB.

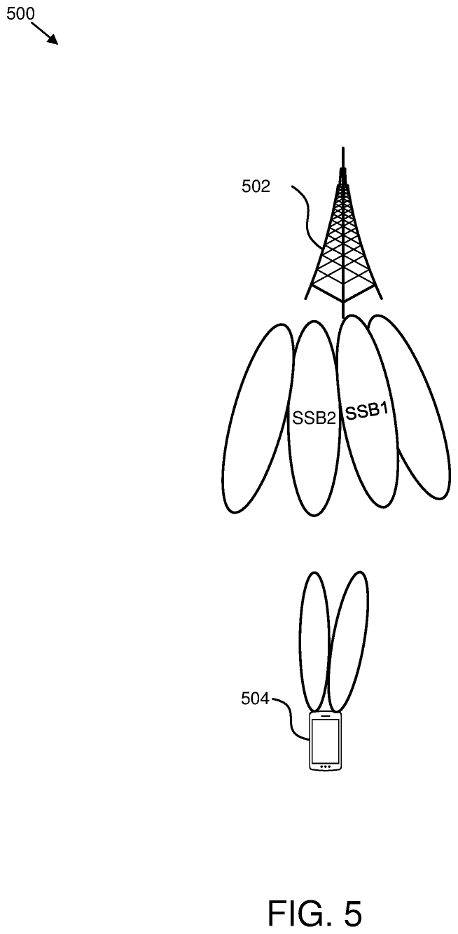

In the second embodiment, a UE may be configured with multiple beams and/or multiple ROs to perform multiple and/or repeated PRACH preamble transmissions for an SSB candidate (e.g., one SSB (synchronization signal (“SS”) and/or physical broadcast channel (“PBCH”) (“SS/PBCH”) block) may be mapped to 1/N consecutive valid PRACH occasions where a number N (N<1) of SS/PBCH blocks is associated with one PRACH occasion). The number of repetitions may be explicitly configured via radio resource control (“RRC”) signaling (e.g., RACH-ConfigCommon IE) or may implicitly depend on a configured subcarrier spacing (“SCS”). In some embodiments, a UE may select a number of repetitions based on an RSRP level of a detected SSB. In one example, the UE upon detecting the SSB may perform PRACH preamble repetition on a configured RO for each repetition. In another example, the UE may use one or more narrow beams (e.g., narrower than the SSB beam and/or the receive beam used for receiving the SSB) (e.g., similar beams but not identical) for PRACH preamble transmission in the same direction of the SSB beam. In a further example, to assist the UE in determining narrower beams, one or more channel state information (“CSI”) reference signal (“RS”) (“CSI-RS”) may be transmitted by a gNB with a quasi-collocation assumption of Type-D (“Spatial Rx”) with the SSB beam (e.g., SSB2 in FIG. 5). The UE may adjust its RX beam based on measurements on the CSI-RS, which may be transmitted with a narrower beam width than the SSB. The configuration of the CSI-RS (e.g., time and/or frequency resource, repetition, etc.) associated with the SSB beam may be indicated in SIB1 (System Information Block 1) for contention-based RA. The usage of narrow beams (e.g., similar but not identical to the receive beam and/or spatial filter used for the receiving the SSB; the narrow beam and/or spatial transmission filter at least partially overlapping with the receive beam and/or spatial filter used for receiving the SSB and/or based on the CSI-RS measurements) may not be considered as a change in the spatial domain transmission filter (e.g., exception condition) and may not result in notifying higher layers to suspend a power ramping counter. The UE may use the same transmit power (e.g., without power ramping across the repetitions). The transmit power may be based on a beamforming gain of a narrow beam relative to a receive beam and/or spatial filter used for receiving the SSB (e.g., the transmit power for the narrow beam may be reduced by the relative beamforming gain factor compared to using a spatial transmission filter that is the same as the spatial receive filter for receiving the SSB).

FIG. 5 is a schematic block diagram illustrating one embodiment of a system 500 for multiple and/or narrow beam PRACH preamble transmission. The system 500 includes a network device 502 (e.g., gNB) that transmits a first SSB (“SSB1”), and a second SSB (“SSB2”). The system 500 also includes a user equipment 504.

In various embodiments, a number of beams and a beam width of each beam may be preconfigured by higher layers. In certain embodiments, a number of the beams and/or a beam width may be chosen based on a predefined RSRP threshold of a detected SSB. In one example, for each of the frequency bands, a UE may be pre-configured with a table mapping RSRP (or similar metric) to a number of TX beams (or repetitions) for PRACH transmissions, as shown in Table 1.

TABLE 1

| RSRP Threshold | Number of TX beams/repetitions for PRACH |
|---|---|
| R1 | 1 |
| R2 | 2 |
| R3 | 4 |
| R4 | 8 |

According to Table 1, if the RSRP threshold measured from SSB is above R1, then the UE is expected to use a single beam (single transmission) for PRACH on a TX beam corresponding to the RX beam (e.g., used for receiving a corresponding SSB). If the RSRP threshold is below R1 but above R2 measured from SSB, then the UE is expected to use two beams (e.g., two repetitions and/or transmissions) for PRACH on two TX beams corresponding to 1 RX beam (e.g., used for receiving corresponding SSB). In such embodiments, the UE may assume the TX beam width to be half of a corresponding TX beam width where the TX beam is the PRACH beam from the UE corresponding to the RX beam spatial filter used for receiving SSB. Similarly, for an RX threshold, 4 TX beams may be assumed with a beam width one-fourth of the corresponding RX beam width. In such an example, one SSB is associated with more than one RO, then each of these RO may be used for such repetitions with smaller beam widths. In another is example, one or more ROs can be associated with a single SSB and the UE may repeat a PRACH transmission in one or more ROs. Each of the ROs may be associated with different TX beams of a UE.

In certain embodiments, a UE performs preamble repetition on predefined ROs, and a gNB may try PRACH detection for each RO and accumulate and/or combine the preamble with the next RO repetition until the preamble is correctly detected. The gNB may send a RAR message to the UE before the number of the configured repetitions is achieved. Upon receiving a RAR message, the UE terminates on-going repetitions of PRACH.

In some embodiments, multiple PRACH preamble transmissions may result in multiple parallel RACH processes and these RACH processes may be terminated once a RAR is received.

In a third embodiment, a SCS of a PRACH preamble may be adapted for each RACH attempt. In such an embodiment, the SCS may affect the performance of PRACH preamble transmission. For example, high SCS may lead to poor performance if a short preamble is used. This may occur due to a short time length of the preamble and limited collected energy. According to the third embodiment, the UE is configured with multiple ROs, each with different SCS configurations. The UE may be configured with time division multiplexed (“TDMed”) ROs with different SCS. In one example, multiplexing ROs in frequency may be in the different bandwidth parts (“BWPs”).

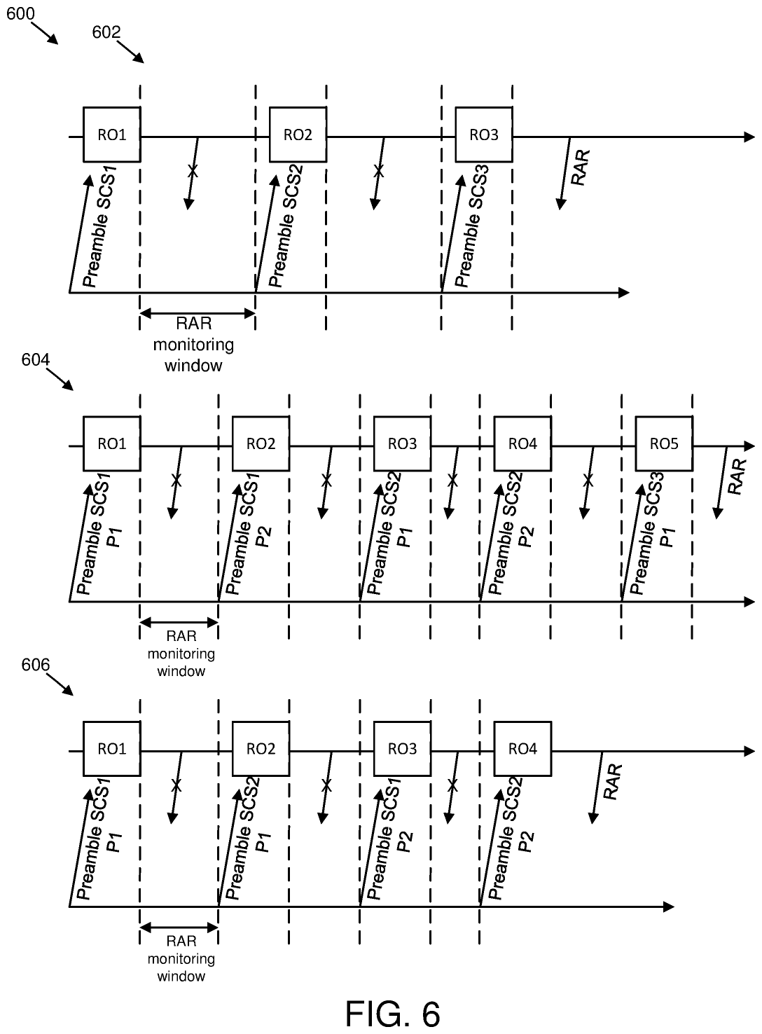

In another example, ROs with a first SCS configuration may correspond to a first PRACH occasions mapping cycle within an association period (e.g., mapping cycle and association period as defined) and ROs with a second SCS configuration may correspond to a second PRACH occasions mapping cycle within an association period, with an integer number of SS/PBCH block indexes to PRACH occasions mapping cycles within the association period. The UE, upon detecting an SSB candidate, transmits a PRACH preamble with a default SCS and waits for a RAR message. If, during a monitoring window of RAR, the UE doesn't receive a response, the UE may retransmit the PRACH preamble with a next configured SCS as shown in FIG. 6. The UE may perform both power ramping and an SCS change at substantially the same time. In various embodiments, the UE may perform some iterations with power ramping and, after a predefined number of iterations, may switch to different SCS. In certain embodiments, a PRACH preamble is repeated in a configured RO without waiting for a RAR.

FIG. 6 is a schematic block diagram 600 illustrating embodiments of PRACH preamble transmission with different SCS. In a first timing diagram 602, the same power is used with different SCS until a RAR is received. In a second timing diagram 604, different power is used with different SCS until a RAR is received, wherein the SCS is changed after different powers are attempted. In a third timing diagram 606, different power is used with different SCS until a RAR is received, wherein the power is changed after different SCS are attempted.

In certain embodiments, a UE may perform some iteration with a configured SCS and if it fails, it ramps the power for the next retransmission. The number of attempts for different SCSs, power ramping, or both may be signaled to the UE along with an RRC RACH configuration.

In a fourth embodiment, there may be Msg3 repetition and hopping. According to the fourth embodiment, a UE is configured with multiple UL grants and/or repetitions for Msg3. In one implementation of the fourth embodiment, a number of repetitions may be associated with a number of PRACH repetitions. In such an implementation, an indication of the number of the PRACH repetitions may be used for Msg3 as well. In another implementation of the fourth embodiment, a number of the repetitions may be configured via RAR downlink control information (“DCI”) or RRC. In a further implementation of the fourth embodiment, a number of Msg3 repetitions may be associated with a number of the PRACH attempts. For example, more Msg3 repetitions may be applied if a number of PRACH attempts (e.g., retransmissions) is high (e.g., above a threshold), and a number of repetitions is reduced if a UE receives a RAR message after one attempt or a small number of attempts. The gNB may perform joint detection of multiple Msg3 PUSCH slots—for example, by configuring a shared DMRS pattern between Msg3 slots and performs inter-slot channel estimation. The gNB may try PUSCH decoding for each configured UL slot for Msg3 repetition, and if it fails, a joint decoding with the next slot may be performed until it correctly decodes the message. The gNB may send a Msg4 to the UE before a number of configured repetitions is achieved. Upon receiving an indication, a UE terminates on-going repetition.

In some embodiments, a UE may be configured to perform slot hopping (e.g., inter and/or intra) for each repetition of Msg3. In one implementation of such embodiments, a number of frequency positions or hops may be configured via RAR DCI or RRC. In another implementation of such embodiments, a number of Msg3 hops may be associated with a number of the PRACH attempts. For example, more Msg3 hops may be applied if a number of PRACH attempts (e.g., retransmissions) is high. In various embodiments, a number of hops may be implicitly indicated based on a configured SCS.

In a fifth embodiment, there may be MsgA repetition. According to the fifth embodiment, for 2-step RACH, a UE may be configured with multiple ROs to perform MsgA preamble repetition and multiple resources for Msg A PUSCH repetition. In one implementation of the fifth embodiment, a repetition of MsgA PUSCH may be performed after all MsgA preamble repetitions are performed. In another implementation of the fifth embodiment, to reduce latency, MsgA PUSCH is repeated after each preamble repetition. In such an implementation, the number of MsgA PUSCH repetitions and MsgA PRACH preamble repetitions are equal. In another implementation of the fifth embodiment, MsgA PUSCH is repeated after each preamble transmission. In such an implementation, MsgA PUSCH may be repeated for each RACH preamble transmission. A different redundancy version (“RV”) cycle may be configured (e.g., or preconfigured) for MsgA PUSCH by RRC signaling or s system information block (“SIB”). A gNB combines the signals from the different repetitions (and/or different RV) to perform MsgA decoding. In one implementation of the fifth embodiment, the gNB combines all signals from all the configured UL slots for MsgA to perform decoding. In such an implementation, the UE does not expect MsgB between a repetition and starts monitoring after all repetitions are performed. A time gap in terms of slots may be configured (e.g., preconfigured) for the Msg A transmission and repetition and MsgB receptions by RRC signaling or SIB.

In various embodiments, a number of repetition for Msg A PUSCH and/or Msg A preambles may be configured (e.g., preconfigured) based on a SSB RSRP. The number of repetitions for Msg A PUSCH may be separately configured compared to Msg A preamble repetition.

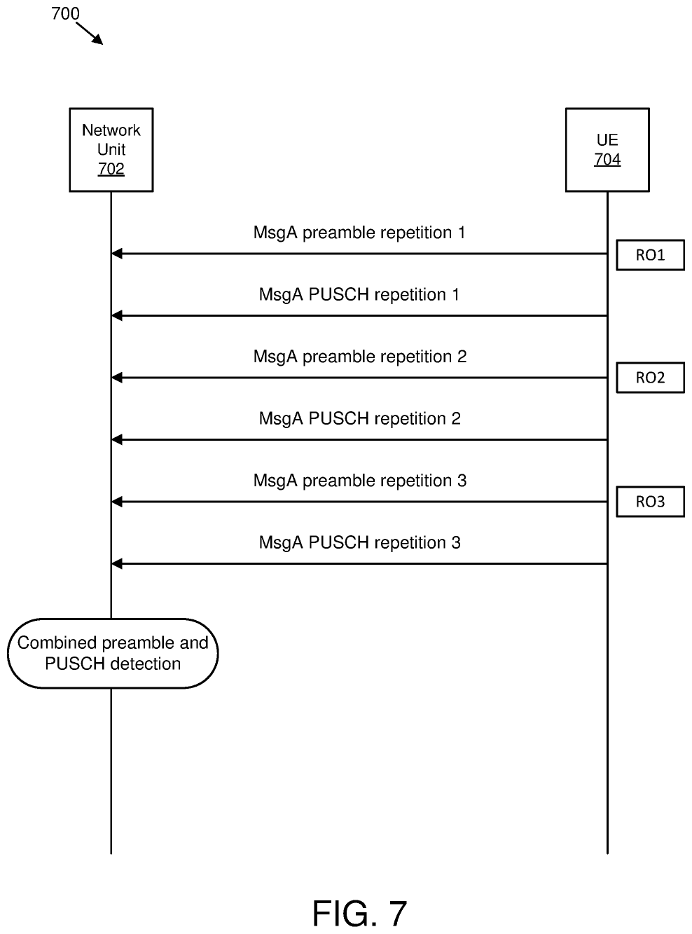

FIG. 7 is a flow chart diagram illustrating one embodiment of a 2-step RACH procedure 700 with repetition. Communications between a network unit 702 and a UE 704 are illustrated. In this procedure 700, first repetitions of a MsgA preamble and a MsgA PUSCH are sent from the UE 704 to the network unit 702, second repetitions of a MsgA preamble and a MsgA PUSCH are sent from the UE 704 to the network unit 702, third repetitions of a MsgA preamble and a MsgA PUSCH are sent from the UE 704 to the network unit 702, and then the network unit 702 performs combined preamble and PUSCH detection.

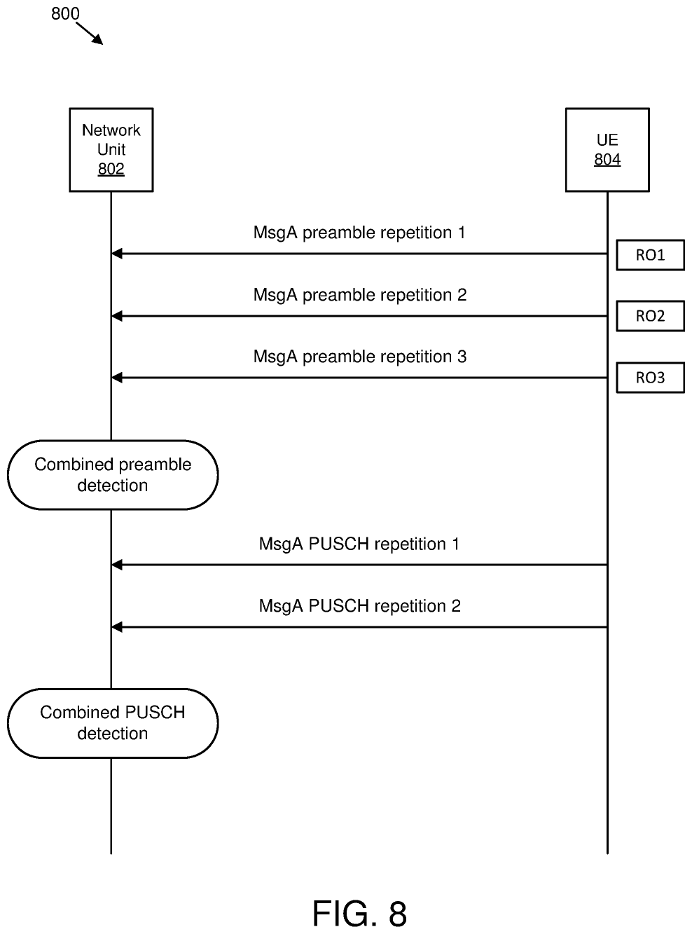

FIG. 8 is a flow chart diagram illustrating another embodiment of a 2-step RACH procedure 800 with repetition. Communications between a network unit 802 and a UE 804 are illustrated. In this procedure 800, a first repetition of a MsgA preamble, a second repetition of a MsgA preamble, and a third repetition of a MsgA preamble are from the UE 804 to the network unit 802, and then the network unit 802 performs combined preamble detection. Next, a first repetition of a MsgA PUSCH and a second repetition of a MsgA PUSCH are from the UE 804 to the network unit 802, and then the network unit 802 performs combined PUSCH detection.

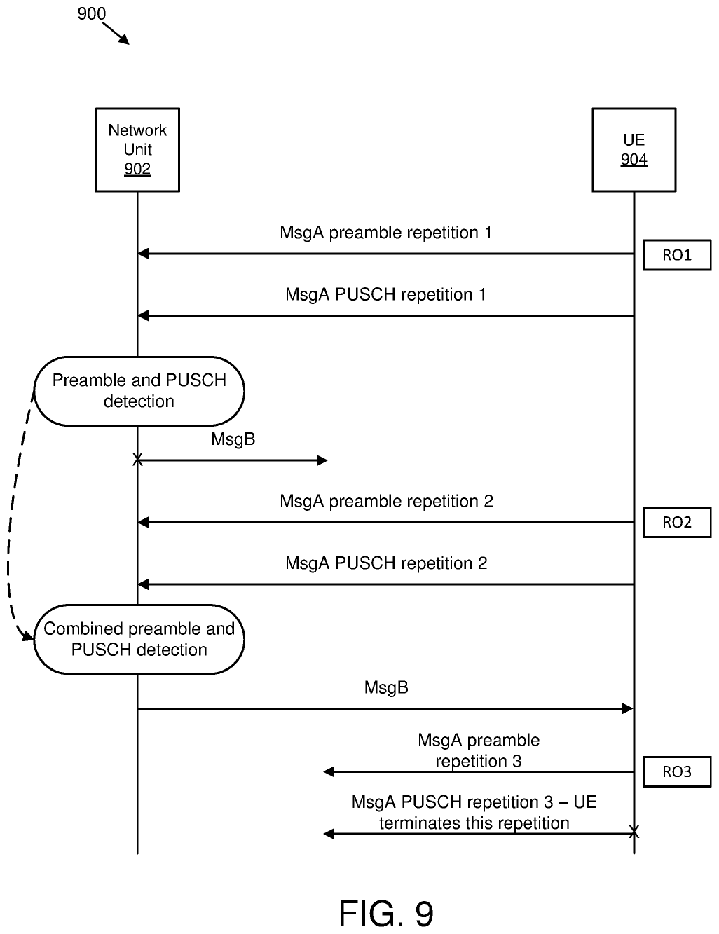

FIG. 9 is a flow chart diagram 900 illustrating a further embodiment of a 2-step RACH procedure with repetition and termination. Communications between a network unit 902 (e.g., gNB) and a UE 904 are illustrated. In another implementation of the fifth embodiment, as illustrated in FIG. 9, for early termination of repetition, the gNB 902 may try to decode the first MsgA, if it fails, then the received signal is combined with the next MsgA slot by utilizing the diversity or cross slot channel estimation until the decoding is succeeded, then it directly sends MsgB. Upon receiving MsgB, the UE 904 terminates the on-going MsgA repetition. In such an embodiment, the UE expects and/or monitors for MsgB after each repetition.

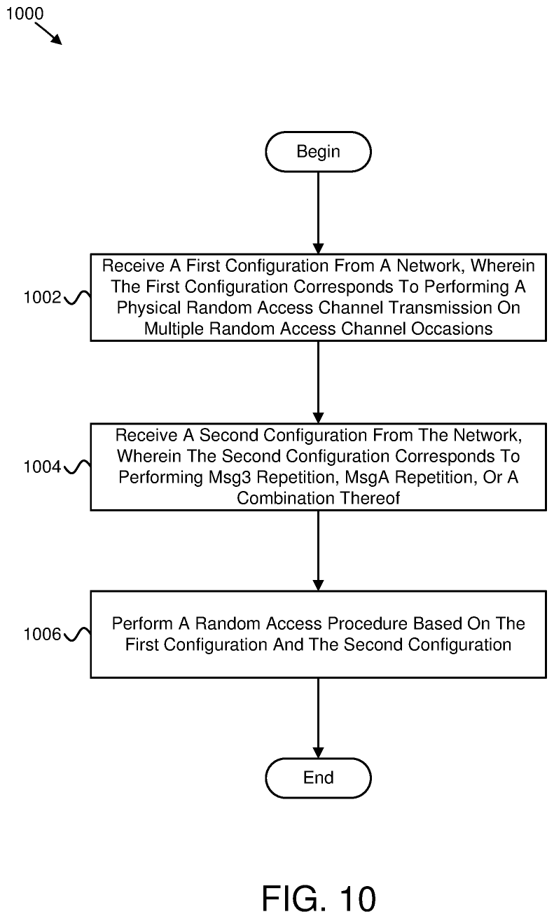

FIG. 10 is a flow chart diagram illustrating one embodiment of a method 1000 for configuring random access procedures. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002 a first configuration from a network. The first configuration corresponds to performing a physical random access channel transmission on multiple random access channel occasions. In some embodiments, the method 1000 includes receiving 1004 a second configuration from the network. The second configuration corresponds to performing Msg3 repetition, MsgA repetition, or a combination thereof. In certain embodiments, the method 1000 includes performing 1006 a random access procedure based on the first configuration and the second configuration.

In certain embodiments, the first configuration comprises an indication to use multiple physical random access channel preamble transmissions for each detected synchronization signal block. In some embodiments, the first configuration comprises an indication of a pre-defined table for listing synchronization signal block candidates based on a pre-defined reference signal received power threshold. In various embodiments, the method 1000 further comprises configuring transmission of a random access channel preamble on a random access channel occasions associated with each detected synchronization signal block candidate that satisfies a predefined reference signal received power threshold.

In one embodiment, the method 1000 further comprises configuring the multiple random access channel occasions with physical random access channel repetition or multi-beam transmission in response to detecting at least one synchronization signal block candidate. In certain embodiments, the method 1000 further comprises receiving information indicating a is number of repetitions of beams explicitly along with a radio resource control random access channel configuration, implicitly based on a subcarrier spacing, or based on a predefined reference signal received power threshold of a synchronization signal block. In some embodiments, the method 1000 further comprises configuring the multiple random access channel occasions, wherein each random access channel occasions of the multiple random access channel occasions is configured with a different subcarrier spacing.

In various embodiments, the method 1000 further comprises making one random access channel attempt per one subcarrier spacing, and changing the subcarrier spacing if no random access response message is received during a random access response monitoring time. In one embodiment, the method 1000 further comprises configuring a subcarrier spacing change to be combined with power ramping for each subcarrier spacing attempt by trying different subcarrier spacings for some attempts and switching the subcarrier spacing if no random access response message is received. In certain embodiments, the method 1000 further comprises configuring, for 2-step random access channel, to perform repetition of MsgA with a different number of repetitions for a MsgA preamble and a MsgA physical uplink shared channel, and performing a first preamble repetition then MsgA repetition, wherein multiple MsgA preambles are combined to detect a preamble, the multiple MsgA physical uplink shared channels are combined to decode physical uplink shared channel information.

In some embodiments, the method 1000 further comprises performing repetition of a MsgA preamble and a MsgA physical uplink shared channel, wherein combined detection of the MsgA preamble and the MsgA physical uplink shared channel is performed. In various embodiments, per repetition decoding of transmissions is performed, and slots are combined if there is a failure. In one embodiment, the method 1000 further comprises receiving a MsgB as an implicit indication to terminate on-going repetition.

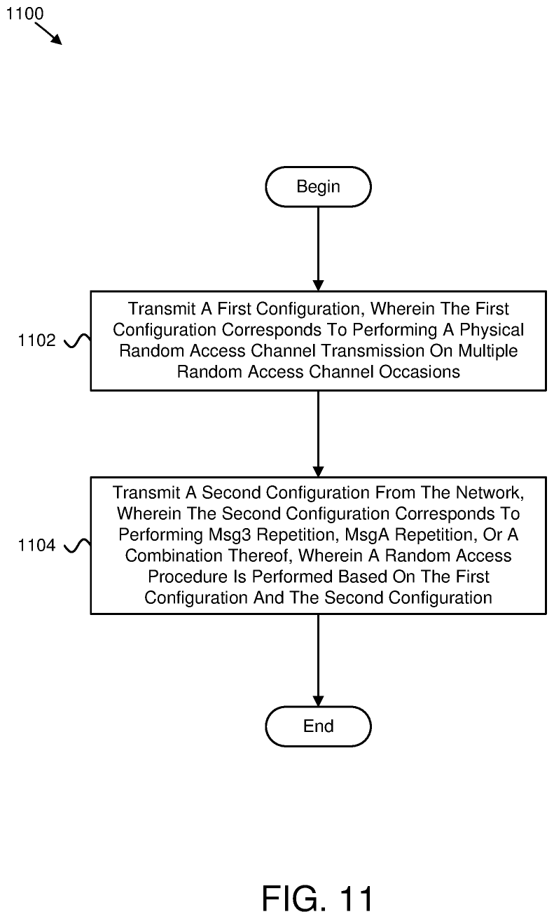

FIG. 11 is a flow chart diagram illustrating another embodiment of a method 1100 for configuring random access procedures. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes transmitting 1102 a first configuration. The first configuration corresponds to performing a physical random access channel transmission on multiple random access channel occasions. In some embodiments, the method 1100 includes transmitting 1104 a second configuration from the network. The second configuration corresponds to performing Msg3 repetition, MsgA repetition, or a combination thereof. A random access procedure is performed based on the first configuration and the second configuration.

In certain embodiments, the first configuration comprises an indication to use multiple physical random access channel preamble transmissions for each detected synchronization signal block. In some embodiments, the first configuration comprises an indication of a pre-defined table for listing synchronization signal block candidates based on a pre-defined reference signal received power threshold.

In various embodiments, the method 1100 further comprises transmitting information indicating a number of repetitions of beams explicitly along with a radio resource control random access channel configuration, implicitly based on a subcarrier spacing, or based on a predefined reference signal received power threshold of a synchronization signal block. In one embodiment, the method 1100 further comprises transmitting a MsgB as an implicit indication to terminate on-going repetition.

In one embodiment, a method of a user equipment comprises: receiving a first configuration from a network, wherein the first configuration corresponds to performing a physical random access channel transmission on multiple random access channel occasions; receiving a second configuration from the network, wherein the second configuration corresponds to performing Msg3 repetition, MsgA repetition, or a combination thereof; and performing a random access procedure based on the first configuration and the second configuration.

In certain embodiments, the first configuration comprises an indication to use multiple physical random access channel preamble transmissions for each detected synchronization signal block.

In some embodiments, the first configuration comprises an indication of a pre-defined table for listing synchronization signal block candidates based on a pre-defined reference signal received power threshold.

In various embodiments, the method further comprises configuring transmission of a random access channel preamble on a random access channel occasions associated with each detected synchronization signal block candidate that satisfies a predefined reference signal received power threshold.

In one embodiment, the method further comprises configuring the multiple random access channel occasions with physical random access channel repetition or multi-beam transmission in response to detecting at least one synchronization signal block candidate.

In certain embodiments, the method further comprises receiving information indicating a number of repetitions of beams explicitly along with a radio resource control random access channel configuration, implicitly based on a subcarrier spacing, or based on a predefined reference signal received power threshold of a synchronization signal block.

In some embodiments, the method further comprises configuring the multiple random access channel occasions, wherein each random access channel occasions of the multiple random access channel occasions is configured with a different subcarrier spacing.

In various embodiments, the method further comprises making one random access channel attempt per one subcarrier spacing, and changing the subcarrier spacing if no random access response message is received during a random access response monitoring time.

In one embodiment, the method further comprises configuring a subcarrier spacing change to be combined with power ramping for each subcarrier spacing attempt by trying different subcarrier spacings for some attempts and switching the subcarrier spacing if no random access response message is received.

In certain embodiments, the method further comprises configuring, for 2-step random access channel, to perform repetition of MsgA with a different number of repetitions for a MsgA preamble and a MsgA physical uplink shared channel, and performing a first preamble repetition then MsgA repetition, wherein multiple MsgA preambles are combined to detect a preamble, the multiple MsgA physical uplink shared channels are combined to decode physical uplink shared channel information.

In some embodiments, the method further comprises performing repetition of a MsgA preamble and a MsgA physical uplink shared channel, wherein combined detection of the MsgA preamble and the MsgA physical uplink shared channel is performed.

In various embodiments, per repetition decoding of transmissions is performed, and slots are combined if there is a failure.

In one embodiment, the method further comprises receiving a MsgB as an implicit indication to terminate on-going repetition.

In one embodiment, an apparatus comprises a user equipment. The apparatus further comprises: a receiver that: receives a first configuration from a network, wherein the first configuration corresponds to performing a physical random access channel transmission on multiple random access channel occasions; and receives a second configuration from the network, wherein the second configuration corresponds to performing Msg3 repetition, MsgA repetition, or a combination thereof; and a processor that performs a random access procedure based on the first configuration and the second configuration.

In certain embodiments, the first configuration comprises an indication to use multiple physical random access channel preamble transmissions for each detected synchronization signal block.

In some embodiments, the first configuration comprises an indication of a pre-defined table for listing synchronization signal block candidates based on a pre-defined reference signal received power threshold.

In various embodiments, the processor configures transmission of a random access channel preamble on a random access channel occasions associated with each detected synchronization signal block candidate that satisfies a predefined reference signal received power threshold.

In one embodiment, the processor configures the multiple random access channel occasions with physical random access channel repetition or multi-beam transmission in response to detecting at least one synchronization signal block candidate.

In certain embodiments, the receiver receives information indicating a number of repetitions of beams explicitly along with a radio resource control random access channel configuration, implicitly based on a subcarrier spacing, or based on a predefined reference signal received power threshold of a synchronization signal block.

In some embodiments, the processor configures the multiple random access channel occasions, wherein each random access channel occasions of the multiple random access channel occasions is configured with a different subcarrier spacing.

In various embodiments, the processor makes one random access channel attempt per one subcarrier spacing, and changes the subcarrier spacing if no random access response message is received during a random access response monitoring time.

In one embodiment, the processor configures a subcarrier spacing change to be combined with power ramping for each subcarrier spacing attempt by trying different subcarrier spacings for some attempts and switching the subcarrier spacing if no random access response message is received.

In certain embodiments, the processor configures, for 2-step random access channel, to perform repetition of MsgA with a different number of repetitions for a MsgA preamble and a MsgA physical uplink shared channel, and performs a first preamble repetition then MsgA repetition, wherein multiple MsgA preambles are combined to detect a preamble, the multiple MsgA physical uplink shared channels are combined to decode physical uplink shared channel information.

In some embodiments, the processor performs repetition of a MsgA preamble and a MsgA physical uplink shared channel, and combined detection of the MsgA preamble and the MsgA physical uplink shared channel is performed.

In various embodiments, per repetition decoding of transmissions is performed, and slots are combined if there is a failure.

In one embodiment, the receiver receives a MsgB as an implicit indication to terminate on-going repetition.

In one embodiment, a method of a network device comprises: transmitting a first configuration, wherein the first configuration corresponds to performing a physical random access channel transmission on multiple random access channel occasions; and transmitting a second configuration from the network, wherein the second configuration corresponds to performing Msg3 repetition, MsgA repetition, or a combination thereof, wherein a random access procedure is performed based on the first configuration and the second configuration.

In certain embodiments, the first configuration comprises an indication to use multiple physical random access channel preamble transmissions for each detected synchronization signal block.

In some embodiments, the first configuration comprises an indication of a pre-defined table for listing synchronization signal block candidates based on a pre-defined reference signal received power threshold.

In various embodiments, the method further comprises transmitting information indicating a number of repetitions of beams explicitly along with a radio resource control random access channel configuration, implicitly based on a subcarrier spacing, or based on a predefined reference signal received power threshold of a synchronization signal block.

In one embodiment, the method further comprises transmitting a MsgB as an implicit indication to terminate on-going repetition.

In one embodiment, an apparatus comprises a network device. The apparatus further comprises: a transmitter that: transmits a first configuration, wherein the first configuration corresponds to performing a physical random access channel transmission on multiple random access channel occasions; and transmits a second configuration from the network, wherein the second configuration corresponds to performing Msg3 repetition, MsgA repetition, or a combination thereof, wherein a random access procedure is performed based on the first configuration and the second configuration.

In certain embodiments, the first configuration comprises an indication to use multiple physical random access channel preamble transmissions for each detected synchronization signal block.

In some embodiments, the first configuration comprises an indication of a pre-defined table for listing synchronization signal block candidates based on a pre-defined reference signal received power threshold.

In various embodiments, the transmitter transmits information indicating a number of repetitions of beams explicitly along with a radio resource control random access channel configuration, implicitly based on a subcarrier spacing, or based on a predefined reference signal received power threshold of a synchronization signal block.

In one embodiment, the transmitter transmits a MsgB as an implicit indication to terminate on-going repetition.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment (UE), the method comprising:
receiving a first configuration from a network, wherein the first configuration corresponds to performing a physical random access channel (PRACH) transmission on multiple random access channel (RACH) occasions;
receiving a second configuration from the network, wherein the second configuration corresponds to performing Msg3 repetition, MsgA repetition, or a combination thereof; and
performing a random access procedure based on the first configuration and the second configuration.

2. The method of claim 1, wherein the first configuration comprises an indication to use multiple PRACH preamble transmissions for each detected synchronization signal block (SSB).

3. The method of claim 1, further comprising configuring the multiple RACH occasions with PRACH repetition or multi-beam transmission in response to detecting at least one synchronization signal block (SSB) candidate.

4. The method of claim 1, further comprising receiving information indicating a number of repetitions of beams explicitly along with a radio resource control (RRC) RACH configuration, implicitly based on a subcarrier spacing, or based on a predefined reference signal received power threshold of a synchronization signal block (SSB).

5. The method of claim 1, further comprising configuring the multiple RACH occasions, wherein each RACH occasions of the multiple RACH occasions is configured with a different subcarrier spacing.

6. The method of claim 5, further comprising making one RACH attempt per one subcarrier spacing, and changing the subcarrier spacing if no random access response (RAR) message is received during a RAR monitoring time.

7. The method of claim 1, further comprising configuring, for 2-step RACH, to perform repetition of MsgA with a different number of repetitions for a MsgA preamble and a MsgA physical uplink shared channel (PUSCH), and performing a first preamble repetition then MsgA repetition, wherein multiple MsgA preambles are combined to detect a preamble, the multiple MsgA PUSCHs are combined to decode PUSCH information.

8. An apparatus for wireless communication, the apparatus comprising:
a receiver that:
receives a first configuration from a network, wherein the first configuration corresponds to performing a physical random access channel (PRACH) transmission on multiple random access channel (RACH) occasions; and
receives a second configuration from the network, wherein the second configuration corresponds to performing Msg3 repetition, MsgA repetition, or a combination thereof; and
a processor that performs a random access procedure based on the first configuration and the second configuration.

9. The apparatus of claim 8, wherein the first configuration comprises an indication to use multiple PRACH preamble transmissions for each detected synchronization signal block (SSB).

10. The apparatus of claim 8, wherein the processor configures the multiple RACH occasions with PRACH repetition or multi-beam transmission in response to detecting at least one synchronization signal block (SSB) candidate.

11. The apparatus of claim 8, wherein the receiver receives information indicating a number of repetitions of beams explicitly along with a radio resource control (RRC) RACH configuration, implicitly based on a subcarrier spacing, or based on a predefined reference signal received power threshold of a synchronization signal block (SSB).

12. The apparatus of claim 8, wherein the processor configures the multiple RACH occasions, wherein each RACH occasions of the multiple RACH occasions is configured with a different subcarrier spacing.

13. The apparatus of claim 12, wherein the processor makes one RACH attempt per one subcarrier spacing, and changes the subcarrier spacing if no random access response (RAR) message is received during a RAR monitoring time.

14. The apparatus of claim 8, wherein the processor configures, for 2-step RACH, to perform repetition of MsgA with a different number of repetitions for a MsgA preamble and a MsgA physical uplink shared channel (PUSCH), and performs a first preamble repetition then MsgA repetition, wherein multiple MsgA preambles are combined to detect a preamble, the multiple MsgA PUSCHs are combined to decode PUSCH information.

15. (canceled)

16. An apparatus for wireless communication, the apparatus comprising:
a processor; and
a memory coupled to the processor, the memory comprising instructions executable by the processor to cause the apparatus to:
receive, from a network, a first configuration associated with performing a transmission on multiple occasions; and
receive, from the network using a random access response (RAR), a second configuration associated with performing Msg3 repetition; and
perform the transmission based at least in part on the first configuration and the second configuration.

17. The apparatus of claim 16, wherein the RAR indicates a number of repetitions.

18. The apparatus of claim 16, wherein the transmission comprises a physical uplink shared channel (PUSCH) transmission.

19. The apparatus of claim 16, wherein the RAR comprises an uplink (UL) grant.
